(19) United States
(12) Patent Application Publication
(10) Pub. No.: US 2006/0253810 A1
(43) Pub. Date: Nov. 9, 2006

(54) Integrated circuit design to optimize manufacturability

(76) Inventors: Carlo Guardiani, Verona (IT); Nicola Dragone, Vobarno (IT); John Kibarian, Los Altos, CA (US); Enrico Malavasi, Mountain View, CA (US); Rijko Radocic, San Diego, CA (US); Andrzej Strojwas, Pittsburgh, PA (US)

Correspondence Address: MORRISON & FOERSTER LLP, 425 MARKET STREET, SAN FRANCISCO, CA, 94105-2482, US

(21) Appl. No.: 10/572,151

(22) PCT Filed: Sep. 16, 2003
(86) PCT No.: PCT/US03/29758

§ 371 Date: Mar. 15, 2006

(51) Int. Cl. G06F 17/50

(52) U.S. Cl. 716/4

(57) ABSTRACT

Library design elements (102) are analyzed for manufacturability to be used in designing an IC chip to be manufactured using a particular manufacturing process. The library design elements from a library are obtained. Manufacturability attributes (104) of the library design elements are determined for the particular manufacturing process, where manufacturability attributes include yield-related attributes. Library views (106) with manufacturability attributes for the library design elements are then generated, which are utilizing by an electronic design automation (EDA) tool.

### BACKGROUND

1. Field of the Invention

The present application relates to integrated circuit design, and more particularly to designing integrated circuits to optimize manufacturability.

2. Related Art

The design of an integrated circuit (IC) chip is composed of discrete design elements, referred to also as intellectual property (IP) elements, of various size and complexity. The smallest elements are commonly referred to as standard cells. Larger assemblies of elements can be interconnected to produce complete functions, commonly referred to as blocks. Multiple blocks are interconnected to produce an IC chip, which is fabricated.

For the design of IC chips, for a given manufacturing process, it is necessary to produce an assembly of such cells or blocks consistent with the specific manufacturing process, while providing a variety of functionality and performance choices that allow designers to design and optimize a given IC chip. The assembly of such cells and blocks, together with a detailed description of their characteristics, created for a specific manufacturing process, is commonly referred to as a library. The variety of the design elements/components in a library, created for a specific manufacturing technology, enables a design system to create efficient and optimized IC chips. The library design elements (cells and blocks) are organized into dedicated data representations containing different characteristics related to their use in chip design. A particular data representation of a library design element containing such characteristics is referred to as a view.

In a conventional design flow to produce and characterize the properties of a library, test chips are designed and processed in a manufacturing facility to provide information that allows for the design and creation of the library. The test chips contain an array of representative devices and interconnection geometries, which are analyzed to generate device models suitable for use by electrical-level simulators, such as SPICE, that are utilized in the characterization of the library design elements, to produce performance views of the corresponding library design elements. The test chips are also analyzed to generate design rules utilized in the design of the library design elements. The layout of the library design elements is described in library views that, for example, contain footprint information of the library design element. The test chips are also analyzed to create a design kit that provides a user interface for the design of ICs, and that includes the SPICE models, the Design Rules, and the corresponding tools for automated checking of compliance with these rules.

The test chips that are used in conventional design systems, however, do not contain comprehensive structures that are designed for an assessment or prediction of the manufacturability for the passive or active components that are used for the construction of the library and the product ICs. Therefore, it follows that the library design elements that are created by the existing design systems have not been evaluated sufficiently with respect to a prediction of their manufacturability.

Each cell design that is created, utilizing the Design Kit, is represented using a computer readable format, such as GDSII. A number of different representations of each cell design exist in a library, and each representation is known as a cell view. Some cell views are derived from others. For example, the timing view of every cell is created from the SPICE models and the GDSII view via a process called library timing characterization. LEF is an example of a library view that describes the characteristics required by a router, and includes footprint and port location information.

A typical library contains on the order of 500 cells. However, within the assembly of the library cells, there are multiple layout representations for a given logic function. These “variants” provide different performance characteristics that can be chosen and optimized for a specific application. For example, high performance, high power, with low density, or low performance, low power, with high density options for the same logical function, are typically available in the variant versions containing in the library. However, since no library views contain manufacturability attributes, the variants created by the existing art do not provide choices regarding specific manufacturability related factors. Also, existing commercial software applications using the typical library views are not able to extract or use manufacturability characteristics for any design element in the library.

In a synthesis procedure, a high-level hardware description of the functionality of the IC is mapped into basic binary operators and logic arrays (logic decomposition) to produce a representation referred to as uncommitted logic. Using physical library cells or blocks the uncommitted logic is mapped into a specific logic connectivity diagram, often referred to as a gate-level netlist. A block place and route step creates a layout at the block level, consisting of the selected standard cells, and connections in the routing levels to connect all of the elements. The layout is represented in various formats, e.g., GDSII. A final verification step ensures that all the design constraints are met. In other common current practices, two or more of the steps between the high-level hardware description and the block level layout are executed simultaneously by one software application. Design flows with this type of approach are often denoted as “physical synthesis” flows.

In these design flows, the selection of the library design elements is determined by specific design constraints that are limited to the optimization of metrics, such as speed and power, and area considerations. No substantial manufacturability metric is addressed; however, some area based manufacturability models are used to indirectly estimate the chip costs.

### SUMMARY

Library design elements are analyzed for manufacturability to be used in designing an IC chip to be manufactured using a particular manufacturing process. The library design elements from a library are obtained. Manufacturability attributes of the library design elements are determined for the particular manufacturing process, where manufacturability attributes include yield-related attributes. Library views with manufacturability attributes for the library design elements are then generated, which are utilized by an electronic design automation (EDA) tool.

### DESCRIPTION OF DRAWING FIGS.

The present invention can be best understood by reference to the following description taken in conjunction with the accompanying drawing figures, in which like parts may be referred to by like numerals:

FIG. 1 is an exemplary design flow;

FIG. 2 is an exemplary process to determine manufacturability attributes for library design elements;

FIG. 3 depicts an exemplary learning curve;

FIG. 4 depicts an exemplary process to generate library views of library design elements with manufacturability attributes;

FIG. 5 depicts an exemplary process to generate variant design elements;

FIG. 6 depicts an exemplary design flow; and

FIG. 7 depicts another exemplary design flow.

### DETAILED DESCRIPTION

The following description sets forth numerous specific configurations, parameters, and the like. It should be recognized, however, that such description is not intended as a limitation on the scope of the present invention, but is instead provided as a description of exemplary embodiments.

As described above, a library of design elements is typically used to design IC chips. The library includes all the required views of the library design elements, including performance related attributes of the library design elements. However, conventional libraries do not provide library views with manufacturability attributes, which include yield-related attributes, which can, for example, predict the number of good dies per wafer (GDW). It should be recognized that manufacturability also includes various IC characteristics, such as defects, printability, reliability, and the like. Manufacturability ultimately determines the profitability of a design.

In one exemplary embodiment, library design elements are analyzed to determine manufacturability attributes of the library design elements. Library views are then generated for the library elements to include manufacturability attributes in addition to performance attributes. These library views with manufacturability attributes can be used in a design flow to design ICs with increased manufacturability for a given process.

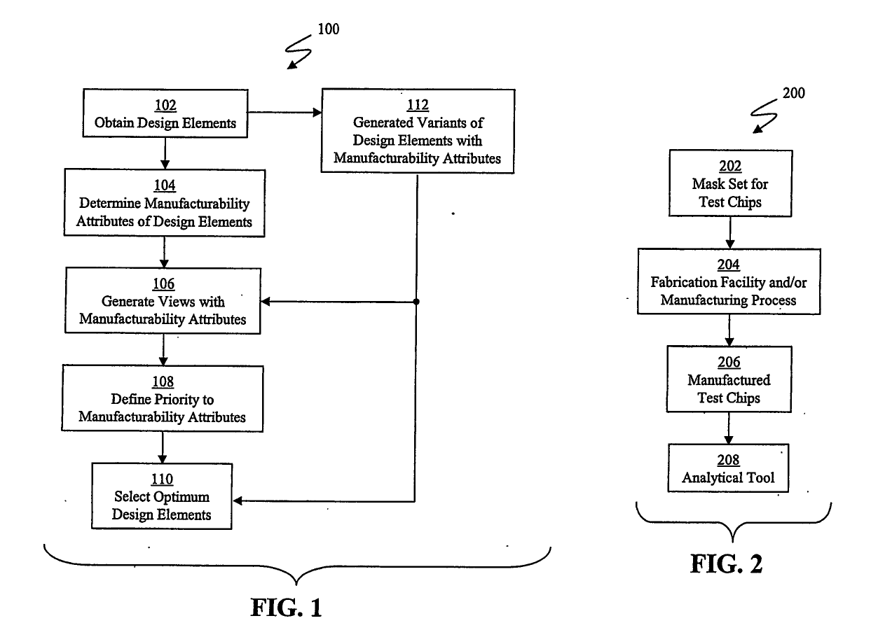

With reference to FIG. 1, an exemplary design flow 100 is depicted. In 102, library design elements are obtained. In 104, manufacturability attributes, which includes yield-related attributes, are determined for the library design elements. In 112, variants of the library design elements are generated, where the variants have different manufacturability attributes than the library design elements. In 106, library views, which are in a computer readable format, of the manufacturability attributes of the library design elements and variants are generated. In 108, a manufacturability estimate of the layout is generated. In 110, optimum design elements are selected for an IC design.

I. Generating Views with Manufacturability Attributes

In one exemplary embodiment, test chips are designed for a specific fabrication facility and/or manufacturing process, taking into account the existing design rules, and the given target manufacturability models. The test chips include a representation of the layout features contained within the existing library design elements. The data extracted from the test chips include the random yield and systematic yield factors of the existing manufacturing process. For a more detailed description of test chips that can be used to determine random and systematic yields, see U.S. Pat. No. 6,449,749, titled SYSTEM AND METHOD FOR PRODUCT YIELD PREDICTION, issued on Sep. 10, 2002, which is incorporated herein by reference in its entirety.

With reference to FIG. 2, an exemplary process 200 is depicted to determine manufacturability attributes for library design elements. In 202, mask sets for test chips are generated. In 204, the mask sets are used in a manufacturing process that is to be used to manufacture the IC. In 206, test chips are manufactured using the mask sets in the manufacturing process. In 208, the manufactured test chips are analyzed using an analytical tool to determine the manufacturability attributes of the manufacturing process, and the manufacturability attributes of the library design elements.

The manufacturability attributes determined from the test chips are then utilized to calibrate various simulator software tools, such as YRS, Optissimo, and the like. The results of the simulations of the manufacturability of the library design elements include a number of manufacturability attributes, including limited yield (LY) of the layout, manufacturing risk factors (MRF), a quantitative description of the process window, and the relationship between LY and MRF. The results of the manufacturing simulations are summarized in library views, which can be utilized by an electronic design automation (EDA) tool.

In one exemplary embodiment, based on historical production characteristics of a given manufacturing process, the current manufacturability attributes, and/or experience with learning rates, the manufacturability attributes of the manufacturing process are estimated for various future points of process maturity. The manufacturability of a given design element is then simulated for various time frames, which corresponds to different process maturity projections, and are also represented in the library views for the corresponding time frames and given library design element.

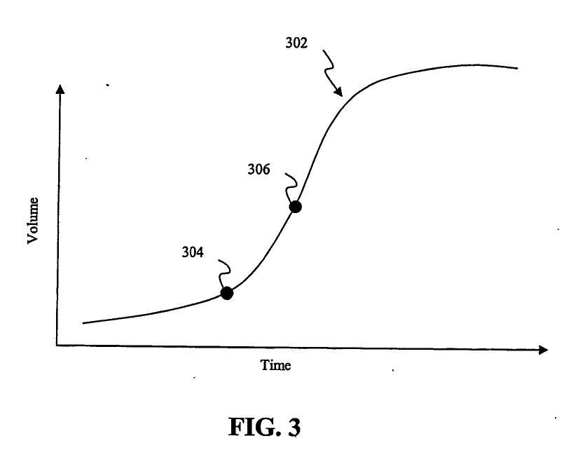

For example, FIG. 3 depicts an exemplary learning curve 302. As depicted in FIG. 3, over a period of time, the volume of ICs produced in a manufacturing process increases. Thus, at a lower volume, a lower yield is obtained at a point 304 in learning curve 302 that corresponds to an earlier period of time than point 306.

In one exemplary embodiment, utilizing statistical design data based on a compilation of representative legacy chip designs and/or blocks of memory/logic configurations, and corresponding manufacturability data, a model that describes the relationship between the manufacturability of the routing used to interconnect the library design elements, and the nature and logic connectivity of the library design elements is defined for a given manufacturing process and design methodology. This relationship is contained in a model, which is also included in the library views.

The library views are contained in a computer readable matrix that tabulates that various manufacturability attributes for a given collection of library design elements for various time frames and includes various interconnect manufacturability models.

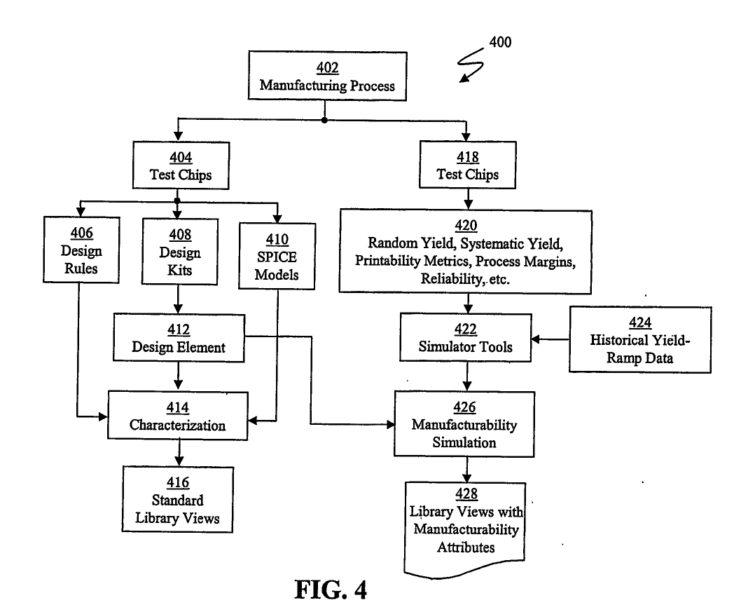

With reference to FIG. 4, an exemplary process 400 is depicted to generate library views of library design elements with manufacturability attributes. In 402, a manufacturing process that is to be used to manufacture an IC design is characterized. For example, in 404, test chips are manufactured using the manufacturing process. In 406, 408, and 410, the manufacturing process is characterized using the test chips to produce design rules, design kits, and SPICE models, respectively. In 412, library vendors produce a library of design elements for the manufacturing process using the design rules, design kits, and SPICE models, which are characterized in 414.

In 416, standard library views of cells are generated based on the design rules, design kits, and SPICE models. For example, a timing view describes the performance characteristics of the cell in the library as a function of cell load and input voltage slope, which is built by performing a number of SPICE simulations. A layout abstract view describes the characteristics required by a router, and includes footprint and port location information. A functional view describes the binary logic function associated with the cell. Other views are used to describe power consumption, signal integrity, etc. attributes of a cell. Views are generally specific to an EDA vendor's tool—i.e., a design tool reads in a cell view in order to determine the properties of the library element that are relevant for the operation performed by the tool. The cell layout view is also described in a compute readable format, such as, for example, GDSII.

In 418, test chips are used to determine a range of manufacturability parameters, many of which are expressed in various forms of yield-related data. For example, in 420, random and systematic yields are determined based on the data acquired from the test chips. In addition, other manufacturability features, such as printability metrics, process margins, and reliability features, are also extracted through the analysis of the test chip data. In 422, a simulator software tool, such as yield ramp simulator (YRS), Optissimo, and the like, is calibrated using yield-related and other manufacturability data.

In 424, historical yield ramp data of various layout features is used by YRS to calibrate the time dependence of such features as a function of a given manufacturability volume.

In 426, a manufacturability simulator is used to analyze each design element in the library to describe its manufacturability attributes. The results of the simulations include limited yield of the layout (LY), manufacturability risk factors (MRF) to describe a process window for the layout in a relative quantitative manner, both LY and MRF vs. time, and a relationship (e.g., a weighing factor) between LY and MRFs. In 428, library views of the library design elements with manufacturability attributes are generated.

II. Generating Variants

In one exemplary embodiment, variants of the library design elements can be created that allow for the enhancement of the manufacturability of the library design elements, usually at a minimal expense of other design parameters, such as area, performance, or power. These variants are functionally equivalent to the original library design elements, but provide specific design alternatives that can enhance the manufacturability properties of the library design elements through effective compromises, e.g., area and/or performance factors.

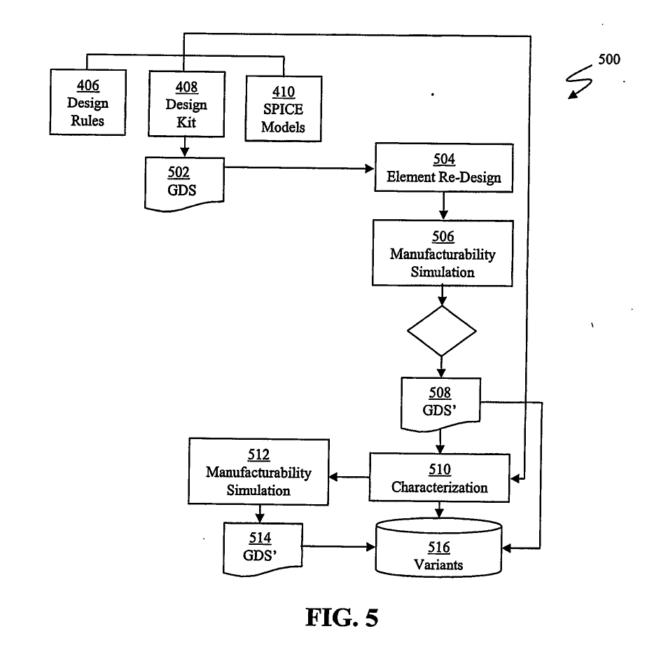

With reference to FIG. 5, an exemplary process 500 is depicted to generate variant design elements (variants). In 406, 408, and 410, design rules, design kits, and SPICE models are produced for a manufacturing process. In 502, a library is generated with library views of cells in a computer readable format, such as GSDII. A typical library may contain about 100 basic logic functions, and for each of these basic functions there are a number of driving capability variants, bringing the total cell count to approximately 500. In 504, a layout is altered to change the manufacturability attribute of the layout. In 506, the manufacturability attributes of the design elements are characterized by evaluation through manufacturability simulations that trade off allowable design constraints, e.g., power, area, for increased manufacturability, within certain prescribed limitations. In 508, library views of the variants are generated. In 510, the variants are characterized to produce the library views that are required by the design tools and flows. In 512, manufacturing attributes of the variants are generated using manufacturability simulations. In 514, library views of the variants with the manufacturing attributes are generated. In 516, the variants are stored. For a more detailed description of generating variants, see U.S. Provisional Application Ser. No. 60/437,922, titled YIELD IMPROVEMENT, filed on Jan. 2, 2003, which is incorporated herein by reference in its entirety.

III. Generate Manufacturability Estimate of Design

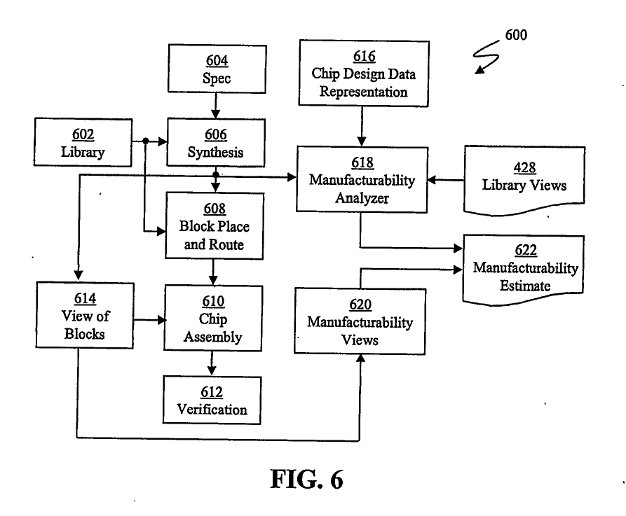

With reference to FIG. 6, an exemplary design flow 600 is depicted. In 602 a library of design elements is obtained. In 604, a high level specification of desired functionality of the circuit is obtained. The specification also includes design constraints/rules, such as performance, power, and area. In 606, a description of the design is produced based on the specification of desired functionality and the library of design elements. In one exemplary embodiment, the description is a netlist, which is a format that contains a list of the standard cells and other building blocks, and defines the connectivity between all the elements. Additionally, in 614, library views of the blocks, such as analog, memory, I/O, etc., are generated. In 608, a layout is created at a block level, which includes selected library design elements, and connections in the routing levels and then all the library design elements are connected. In 610, all the blocks are placed and connected to create a chip layout, using, in part, the library views of the blocks. In 612, the chip layout is verified to confirm that all the design constraints are met and the design rules are not violated.

In 616, a description of the design is imported. The description can be a netlist that describes a block or chip design at a structural level, in other words by specifying it in terms of a list of interconnected basic components, a Register Transfer Level description of desired block or chip functionality, or a layout of an existing block or chip. In 618, the manufacturability of the design is analyzed based on the library views of the library design elements using a manufacturability analyzer. In 622, a manufacturability estimate for the design is generated. The manufacturability estimate can be a function of the manufacturing time frame, and broken down by desired design blocks. In 620 manufacturability views are generated for design blocks in 614, if such views have not as yet been created. The manufacturability estimate in 622 provides a user with the capability to understand the manufacturability characteristics of a given IC or IP block. Additionally, in one exemplary embodiment, the manufacturability estimate can be used to project the time dependence of the manufacturability of a design.

More particularly, for any design element, the characteristics of a virtual learning curve (e.g., the dependence of yield on the manufacturing volume, obtained from historical data) can be inputted into a simulator tool, such as YRS. With reference to FIG. 3, given the user's level of process maturity related to the learning curve, the historical data formatted by a YRS tool can be used to project the yield vs. time for the specific layout features of an IC design. Such information can provide an additional criterion for the selection of variants, allowing for a more accurate cost/profitability projection of the design over the product life. In addition, such a design system allows for a prediction and optimization of the yield of the entire IC design over time, given a level of the process maturity, through the identification of the lowest yielding design elements. As the manufacturing process evolves, the characteristics in terms of manufacturability of the library cells also change and thus the optimal mapping of a block of a chip in terms of library cells can be dynamically adjusted.

IV. Selection of Optimum Design Elements

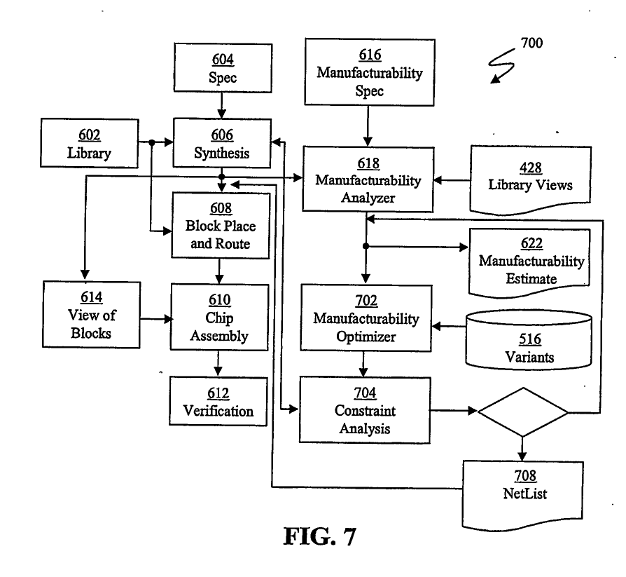

With reference to FIG. 7, an exemplary design flow 700 is depicted to select optimum design elements. In 702, a design is optimized based on manufacturability estimates and variants of the design elements from 516. The design can be optimized by altering the selection-function of a synthesis tool to select cells or blocks based on the manufacturability attributes as well as other design constraints. Alternatively, an existing netlist of a design can be parsed to substitute variants while maintaining the requisite functionality and respecting other design constraints.

In 704, the revised design is analyzed to determine if the revised design complies with design constraints. If a constraint is violated, then a design is incrementally compiled to meet the constraint or an alternative next lower yielding variant with the same functionality is substituted. As depicted in FIG. 7, this process is repeated until the constraints are met. When the constraints are met, a revised design description is generated, such as a revised netlist.

Although exemplary embodiments have been described, various modifications can be made without departing from the spirit and/or scope of the present invention. Therefore, the present invention should not be construed as being limited to the specific forms shown in the drawings and described above.

We claim:

1. A method of analyzing library design elements for manufacturability to be used in designing an IC chip to be manufactured using a particular manufacturing process, the method comprising:
obtaining library design elements from a library;
determining manufacturability attributes of the library design elements for the particular manufacturing process, wherein manufacturability attributes include yield-related attributes; and
generating library views with manufacturability attributes for the library design elements, wherein the library views are utilized by an electronic design automation (EDA) tool.

2. The method of claim 1, wherein determining manufacturability attributes comprises:
generating a test chip design incorporating the library design elements;
manufacturing a test chip using the test chip design and the particular manufacturing process; and
analyzing the fabricated test chip to determine the manufacturability attributes of the library design elements.

3. The method of claim 2, wherein analyzing the fabricated test chip comprises:
comparing a layout feature of a library design element to a layout feature manufactured on the test chip; and
determining a manufacturability attribute for the library design element based on the comparison.

4. The method of claim 2, wherein analyzing the fabricated test chip comprises:
obtaining data from the test chip to populate random yield and systematic yield models.

5. The method of claim 4, further comprising:
determining printability, process margins, and reliability from the test chip.

6. The method of claim 1, further comprising:
creating a variant design element based on a library design element by modifying a feature of the library design element to modify the manufacturability attribute of the library design element.

7. The method of claim 6, further comprising:
determining alterations in design attributes of the variant design element as a result of the modified manufacturability attribute.

8. The method of claim 7, wherein the design attributes include performance, power, area, and yield.

9. The method of claim 6, further comprising:
generating a library view with a manufacturability attribute for the variant design element.

10. The method of claim 9, further comprising:
utilizing library views of library design elements and variant design elements with manufacturability attributes; and
analyzing manufacturability of an IC design based on the library views.

11. The method of claim 10, further comprising:
modifying the IC design by selecting a variant design element.

12. The method of claim 11, further comprising:
determining if a modified design meets a user-specified constraint; and
when the user-specified constraint is not met, modifying the IC design by selecting another variant design element.

13. The method of claim 12, wherein modifying the IC design comprises:
selecting a variant design element using a time dependent yield factor.

14. The method of claim 13, wherein the time dependent yield factor characterizes the change in yield over a period of time.

15. The method of claim 1, further comprising:
for a given manufacturing process and design methodology, defining a model that describes the relationship between manufacturability of routing used to interconnect the library design elements utilizing statistical design data based on a compilation of representative legacy chip designs, blocks of memory or logic configurations, and corresponding manufacturability data.

16. A method of designing an integrated circuit, the method comprising:
obtaining library design elements from a library;
determining manufacturability attributes of the library design elements, wherein manufacturability attributes include yield-related attributes;
generating variant design elements based on the library design elements, wherein the variant design elements have modified manufacturability attributes; and
designing the integrated circuit using the library of design elements and the variant design elements based on the manufacturability attributes of the design elements and the modified manufacturability attributes of the variant design elements.

17. The method of claim 16, wherein determining manufacturability attributes comprises:
designing a test chip design based on the library of design elements;
fabricating a test chip using the test chip design; and
analyzing the fabricated test chip to determine the manufacturability attributes.

18. The method of claim 17, wherein analyzing the fabricated test chip comprises:
obtaining data from the test chip to populate random yield and systematic yield models.

19. The method of claim 18, further comprising:
determining printability, process margins, and reliability from the test chip.

20. The method of claim 16, further comprising:
describing the manufacturability attributes of the library design elements and the modified manufacturability attributes of the variant design elements in a computer readable format.

21. The method of claim 20, wherein the computer readable format is a library view used in an electronic design automation (EDA) tool.

22. The method of claim 21, wherein designing the integrated circuit comprises:
utilizing library views of manufacturability attributes of library design elements and modified manufacturability attributes of the variant design elements; and
analyzing manufacturability of a design layout for the integrated circuit based on the generated library views.

23. The method of claim 22, wherein designing the integrated circuit comprises:
selecting an optimum component for the design layout of the integrated circuit from the library design elements and variant design elements using user-specified constraints.

24. The method of claim 23, wherein selecting an optimum component comprises:
determining if the user-specified constraints are met; and
when the user-specified constraints are not met,
iteratively selecting a variant design element having a modified manufacturability attribute until the user-specified constraints are met.

25. The method of claim 16, wherein designing the integrated circuit comprises:
selecting an optimum component for a design layout of the integrated circuit from the library design elements and variant design elements using a time dependent yield factor.

26. The method of claim 25, wherein the time dependent yield factor characterizes the change in yield over a period of time.

27. The method of claim 25, further comprising:
predicting a yield for the design layout over time based on the lowest yielding components of the design layout.

28. The method of claim 16, further comprising:
for a given manufacturing process and design methodology, defining a model that describes the relationship between manufacturability of routing used to interconnect the library design elements utilizing statistical design data based on a compilation of representative legacy chip designs, blocks of memory or logic configurations, and corresponding manufacturability data.

29. A system of analyzing library design elements for manufacturability to be used in designing an IC chip to be manufactured using a particular manufacturing process, the system comprising:
a library having library design elements; and
a manufacturability simulator configured to:
determine manufacturability attributes of the library design elements, wherein manufacturability attributes include yield-related attributes, and
generate library views with manufacturability attributes for the library design elements.

30. The system of claim 29, further comprising:
a test chip manufactured using the particular manufacturing process, wherein the test chip includes features corresponding to one or more of the library design elements, and wherein the manufacturability simulator analyzes the test chip to determine the manufacturability attributes of the library design elements.

31. The system of claim 30, wherein the test chip includes features to determine data to populate random yield and systematic yield models.

32. The system of claim 31, wherein the test chip includes features to determine printability, process margins, and reliability.

33. The system of claim 29, wherein the manufacturability simulator generates variant design elements corresponding to library design elements by modifying the manufacturability of the library design elements.

34. The system of claim 33, wherein the manufacturability simulator generates library views with manufacturability attributes for the variant design elements.

35. The system of claim 34, further comprising:
a manufacturability analyzer configured to determine a manufacturability estimate of an IC design based on the library views of the library design elements.

36. The system of claim 35, further comprising:
a manufacturability optimizer configured to optimize the IC design based on the manufacturability estimates, the variant design elements, and user-specified constraints.

37. The system of claim 36, wherein the manufacturability optimizer optimizes the IC design based on a time dependent yield factor.

38. The system of claim 29, further comprising:
a model for a given manufacturing process and design methodology that describes the relationship between manufacturability of routing used to interconnect the library design elements, wherein the model is defined utilizing statistical design data based on a compilation of representative legacy chip designs, blocks of memory or logic configurations, and corresponding manufacturability data.
